(19) United States
(12) Patent Application Publication
(10) Pub. No.: US 2011/0040594 A1
(43) Pub. Date: Feb. 17, 2011

(54) Measure selecting apparatus and measure selecting method

(75) Inventors: Hiroshi Nikaido, Kawasaki (JP); Takashi Tada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/923,410

(22) Filed: Sep. 20, 2010

Related U.S. Application Data
(63) Continuation of application No. PCT/JP2008/055295, filed on Mar. 21, 2008.

(51) Int. Cl. G06Q 10/00; G06Q 90/00

(52) U.S. Cl. 705/7; 705/500

(57) ABSTRACT

A measure selecting apparatus includes, a measure candidate selecting unit that calculates, evaluation values indicating the degree of effectiveness of each measure and selects candidates for a measure to be performed. This calculation is performed on the basis of measure data or the like in which a resource included in the business, a measure performed on the resource, and information indicating the length of recovery time of the resource at the time of performing the measure are defined. Measure selecting apparatus also includes an optimum measure selecting unit that selects, in accordance with the evaluation values and the number of same measures included in the candidates selected by the measure candidate selecting unit, a measure to be performed from among the candidate selected by the measure candidate selecting unit.

### CROSS-REFERENCE TO RELATED APPLICATION

This application is a continuation of International Application No. PCT/JP2008/055295, filed on Mar. 21, 2008, the entire contents of which are incorporated herein by reference.

### FIELD

The embodiment discussed herein is directed to a measure selecting apparatus and a measure selecting method.

### BACKGROUND

To grasp or improve tasks, there is a known conventional technology for modeling the contents of the tasks and visualizing the tasks in the form of a diagram or the like. There is also a known technology for visualizing workflows or modeling the contents of business to optimize the company activities.

One such aim of task modeling includes the development of a Business Continuity Plan (BCP). The term BCP is a plan established to allow business to continue as much as possible when various adverse events occur. In BCP development, in general, a diagram referred to an influence diagram is created, and, in accordance with the diagram, actions to be taken are extracted or measures to be taken are designed.

In the influence diagram that is used in BCP, the dependency relation between processes included in business and resources necessary to perform the processes is represented in a predetermined format. With this diagram, it is possible to easily simulate the impact on business continuation when obstacles occur in any one of the resources.

Patent Document 1: Japanese Laid-open Patent Publication No. 2003-308421

Patent Document 2: Japanese Laid-open Patent Publication No. 2006-048145

In order to develop a BCP in accordance with the influence diagram, it is necessary to select an optimum combination from among possible combinations of measures. However, in large business units, an enormous number of possible combinations of measures are present, and also, the dependency relation between resources in the influence diagram becomes complicated. Accordingly, it takes a lot of time to evaluate measures, and it is extremely difficult to select the most effective combination of measures.

Furthermore, to develop a BCP, it is often necessary to select an optimum combination by assuming multiple kinds of disasters. In such a case, the number of possible combinations of measures enormously increases.

### SUMMARY

According to an aspect of an embodiment of the invention, a measure selecting apparatus is for selecting a measure to be performed to make a recovery time required for recovering business equal to or less than a target value. The measure selecting apparatus includes a measure candidate selecting unit that calculates, based on information in which resources that are included in the business, measures that are performed on the resources, and information that indicates a length of recovery time of each resource at the time of performing a corresponding measure are defined, evaluation values indicating degrees of effectiveness of the respective measures, the measure candidate selecting unit selecting at least two candidates for at least one of the measures to be performed, based on the calculated evaluation values; and a measure selecting unit that selects, in accordance with the evaluation values and the number of same measures included in the selected candidates, the at least one of the measures to be performed from among the selected candidates.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram illustrating the configuration of a measure selecting apparatus according to an embodiment;

FIG. 2 is a schematic diagram illustrating an example of task data;

FIG. 3 is a schematic diagram illustrating an example of scenario data;

FIG. 4 is a schematic diagram illustrating an example of task element data;

FIG. 5 is a schematic diagram illustrating an example of task element related data;

FIG. 6 is a schematic diagram illustrating an example of resource data;

FIG. 7 is a schematic diagram illustrating an example of resource RT data;

FIG. 8 is a schematic diagram illustrating an example of measure data;

FIG. 9 is a schematic diagram illustrating an example of weighting coefficient data;

FIG. 10 is a schematic diagram illustrating an example of resource path data;

FIG. 11A is a schematic diagram illustrating an example of measure candidate data;

FIG. 11B is a schematic diagram illustrating an example of measure candidate data in which optimum measures have been selected by an optimum measure selecting unit;

FIG. 12A is a schematic diagram illustrating an example of optimum measure data;

FIG. 12B is a schematic diagram illustrating an example of optimum measure data to which measures of a common resource is added;

FIG. 13 is a flowchart illustrating the flow of a process performed by the measure selecting apparatus;

FIG. 14 is a flowchart illustrating the flow of a measure candidate selecting process;

FIG. 15 is a flowchart illustrating the flow of an optimum measure selecting process;

FIG. 16 is a functional block diagram illustrating a computer that executes a measure selecting program;

FIG. 17 is a schematic diagram illustrating an example of an influence diagram;

FIG. 18 is a schematic diagram illustrating an example of an influence diagram that includes a common resource; and

FIG. 19 is a schematic diagram illustrating an example of an influence diagram that includes the common resource.

### DESCRIPTION OF EMBODIMENT

Preferred embodiments of the present invention will be explained with reference to accompanying drawings. The present invention is not limited to the embodiment described below.

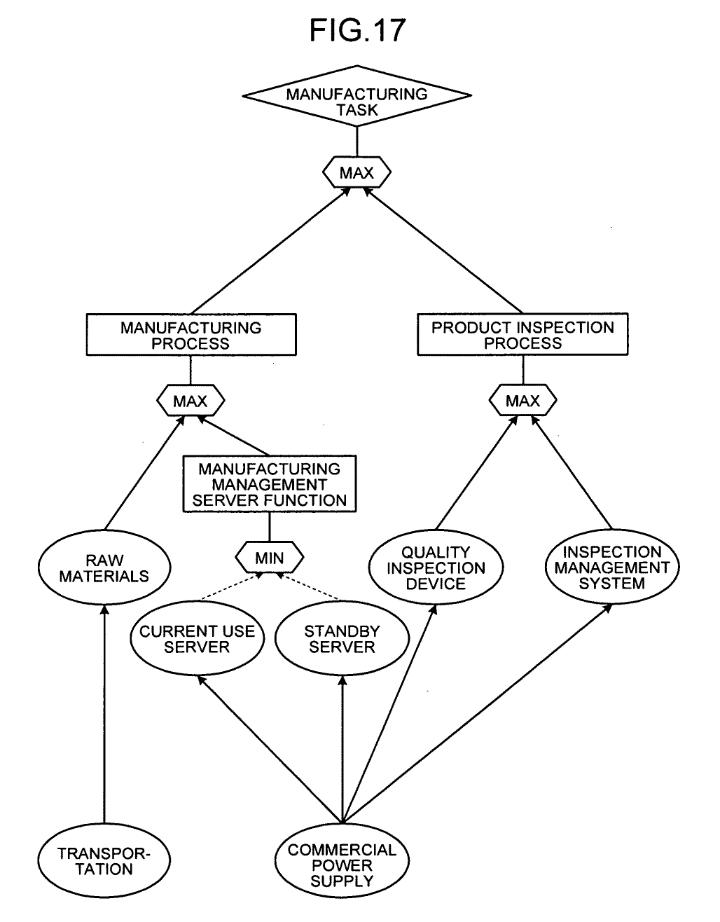

First, an influence diagram that is used in a BCP will be described. FIG. 17 is a schematic diagram illustrating an example of the influence diagram. As illustrated in FIG. 17, in the influence diagram that is used in the BCP, the dependency relation between processes included in business and resources necessary to perform the processes are diagrammed. The influence diagram is used to evaluate, in terms of recovery time, the impact of various kinds of adverse events that occur during continuation of the business.

In the influence diagram, a diamond represents an evaluation node, a rectangle represents a decision node, an oval represents an uncertainty node, and a hexagon represents a utility node. An evaluation node is a node at which the impact of an adverse event is evaluated. A decision node is a node at which an impact on the node is determined by an impact on a lower node being determined. An uncertainty node is a node at which the magnitude of an impact varies in accordance with an adverse event. A utility node is a node that has a predetermined utility. In this example, two kinds of utility nodes are used: a utility node named “MAX” at which a maximum value is selected and a utility node named “MIN” at which a minimum value is selected.

In the following, processes and resources will be considered. If a certain adverse event occurs, it is a resource that is directly impacted by the adverse event. The recovery time of a process is determined in accordance with the recovery time of the resources on which the process depends. Specifically, to recover a process, because it is necessary to recover all of the resources on which the process depends, the recovery time of the process is equal to the maximum value of the recovery time of the resources on which the process depends. Accordingly, in the example illustrated in FIG. 17, processes that are represented as decision nodes are illustrated so as to be connected to, via the utility nodes named “MAX”, resources represented as an uncertainty node.

Furthermore, the recovery time of business, which is a target for the final evaluation that is used to obtain the magnitude of the impact of the adverse event, corresponds to the maximum value of the recovery time of processes included in the business. Accordingly, in the example illustrated in FIG. 17, business represented as an evaluation node is illustrated so as to be connected to, via the utility node “MAX”, processes that are represented as decision nodes.

Furthermore, if there is any replaceable process or resource, a function can be recovered as long as any one of a replaceable process or resource is recovered. Accordingly, nodes that represent replaceable processes or resources are illustrated so as to be connected to, via the utility nodes named “MIN”, to a higher node. For example, because a resource named “current use server” and a resource named “standby server” can be replaced by each other, the uncertainty nodes representing these resources are connected, via the utility node named “MIN”, to a higher decision node named “manufacturing management server function”.

Furthermore, if a certain resource implements its function, in some cases, a function of another resource may be needed. If the dependency relation is established between resources in this manner, the resources having the dependency relation are illustrated such that they are connected to each other. For example, the resource named “raw materials” depends on the resource named “transportation”; therefore, the uncertainty node representing the resource named “raw materials” is connected to the uncertainty node representing the resource named “transportation”.

In this example, because the resource named “raw materials” cannot be recovered until the resource named “transportation” is recovered, the total recovery time of the resource named “raw materials” is evaluated as the value obtained by adding the recovery time of the resource named “raw materials” by itself to the recovery time of the resource named “transportation”.

By creating such an influence diagram, it is possible to obtain, by calculation, the recovery time of business when an adverse event occurs. Specifically, the recovery time (RT) of a “manufacturing task” illustrated in FIG. 17 can be obtained using the equation below:

RT of “manufacturing task”

```
  = MAX (RT of “manufacturing process”, RT of “product
inspection process”)
  = MAX(
    MAX(
    RT of “raw materials” + RT of “transportation”,
    RT of “manufacturing management server function”
    ),
    MAX(
    RT of “quality inspection device” + RT of
“commercial power supply”,
    RT of “inspection management system” + RT of
“commercial power supply”
    )
  )
  = MAX(
    MAX(
    RT of “raw materials” + RT of “transportation”,
      MIN(
      RT of “current use server” + RT of
“commercial power supply”,
      RT of “standby server” + RT of “commercial
power supply”
      )
    ),
    MAX(
    RT of “quality inspection device” + RT of
“commercial power supply”,
    RT of “inspection management system” + RT of
“commercial power supply”
    )
  )
```

The influence diagram illustrated in FIG. 17 has a simple structure for convenience of description; however, the influence diagram that represents business in the real world is far more complicated and an equation for calculating the recovery time (RT) is more complicated. It is extremely difficult to search for an optimum combination from among an enormous number of existing combinations of measures using such a complicated model.

Here, if it is noticed that the minimum value does not exceed the maximum value, the above equation can be changed as below:

RT of “manufacturing task”

```
  ≦ MAX(
    MAX(
    RT of “raw materials” + RT of “transportation”,
      MAX(
      RT of “current use server” + RT of
“commercial power supply”,
      RT of “standby server” + RT of “commercial
power supply”
      )
    ),
    MAX(
    RT of “quality inspection device” + RT of
“commercial power supply”,
    RT of “inspection management system” + RT of
“commercial power supply”
    )
```

```
  )
By further changing this inequality, the following
inequality is obtained:
  RT of “manufacturing task”
  ≦ MAX(
  RT of “raw materials” + RT of “transportation”,
  RT of “current use server” + RT of “commercial power
supply”,
  RT of “standby server” + RT of “commercial power
supply”,
  RT of “quality inspection device” + RT of “commercial
power supply”,
  RT of “inspection management system” + RT “commercial
power supply”
  )
```

Here, each element of the MAX is the sum of the recovery times (RTs) of the resources on paths joining, in accordance with the dependency relation, from the highest-level node to the end nodes included in the influence diagram. For example, a first element is the sum of the recovery time of a resource named “raw materials” and the recovery time of a resource named “transportation”, which are both on the path of “manufacturing task”→“MAX”→“manufacturing process”→“MAX”→“raw materials”→“transportation”. Furthermore, a fifth element is the sum of the recovery time of a resource named “inspection management system” and the recovery time of a resource named “commercial power supply”, which are both on the path of “manufacturing task”→“MAX”→“product inspection process”→“MAX”→“inspection management system”→“commercial power supply”.

In other words, the above inequality indicates that the recovery time of business does not exceed the maximum value of the sum of the recovery times of the resources on the paths joining, in accordance with the dependency relation nodes, nodes from the highest-level node to the end node included in the influence diagram. Accordingly, in order to make the recovery time of business shorter than a certain objective recovery time, when the sum of the recovery times of resources for each path is calculated, a measure is selected in such a manner that the maximum value of the sum of the recovery times is below a target recovery time.

By simplifying the model in this manner, the effect on a measure can be easily evaluated; therefore, it is possible to efficiently select an optimum combination for obtaining necessary improvements from among an enormous number of existing combinations of measures.

When an optimum combination of measures is selected, if there are multiple adverse event scenarios (hereinafter, simply referred to as “scenario”) or tasks, these scenarios or tasks needs to be considered. The term scenario mentioned here means setting information that indicates what kind of adverse event occurs with respect to a task. For example, there may be a case in which a scenario named “fire” and a scenario named “earthquake” are defined as a certain task and a BCP needs to be developed in such a manner that the recovery time in each scenario is set below the target recovery time. In general, if scenarios differ, measures that are used to shorten a recovery time for each resource differ accordingly.

However, from among measures, there may be a measure that is effective for multiple scenarios. For example, a measure of setting up a backup device in a remote location can shorten the recovery time both in the “fire” scenario and in the “earthquake” scenario. In this way, if a measure that is effective for multiple scenarios is given priority use, the recovery time of business can be efficiently reduced, with fewer measures, to be equal to or less than the target value. However, when a measure is selected, in addition to considering whether the measure is effective in multiple scenarios, it is necessary to comprehensively consider, the reduction improvement in the length of recovery time obtained by using the measure, the cost required for implementing a measure, and the like.

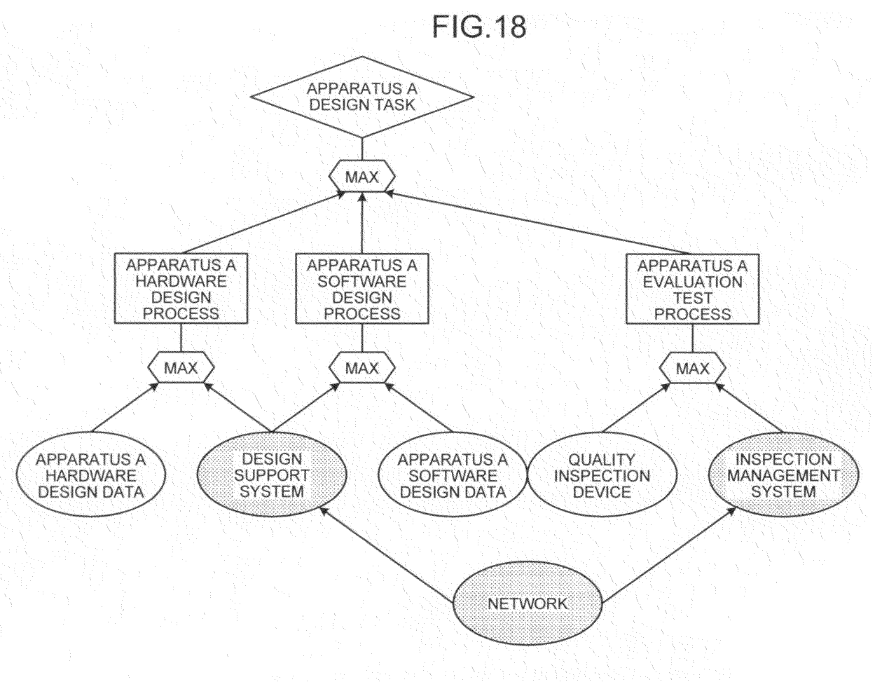

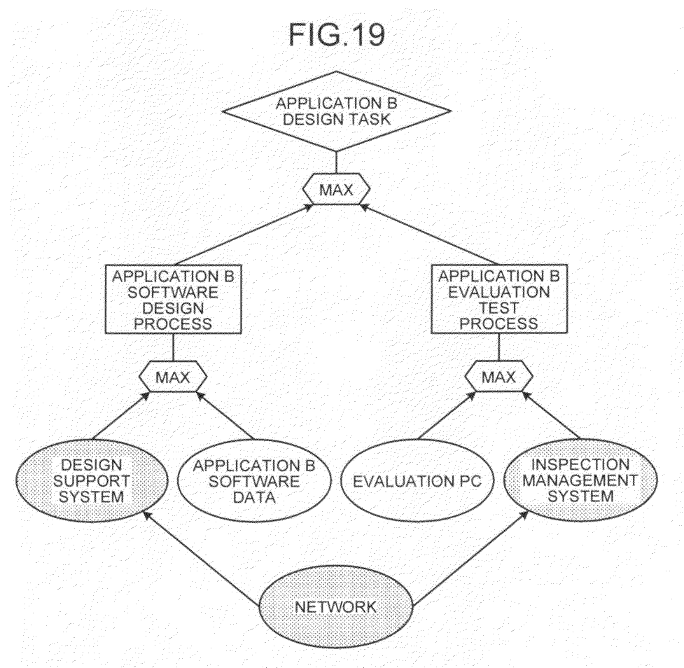

Furthermore, if there are multiple tasks to be developed for a BCP, in some cases, part of a resource may be common to different tasks (hereinafter, a resource that is common to different tasks is referred to as “common resource”). For example, when tasks illustrated in the influence diagram in FIG. 18 are compared with tasks illustrated in the influence diagram in FIG. 19, three common resources are present: a “design support system”, an “inspection management system”, and a “network”. When such common resources are present, if a measure is implemented that uses the common resources in a single task, in some cases, the recovery time of the common resources may also be shortened in another task. Accordingly, selecting, as a priority, a measure that uses common resources is effective in terms of efficiently reducing, with fewer measures, the recovery time of business to be equal to or less than the target value.

In the following, the configuration of a measure selecting apparatus 100 according to the embodiment will be described. The measure selecting apparatus 100 is an apparatus that selects an optimum combination of measures in such a manner that recovery time capability (hereinafter, referred to as “RTC”), which corresponds to the recovery time of business assumed at the time of the occurrence of an adverse event such as an earthquake, to be less than a recovery time objective (hereinafter, referred to as “RTO”).

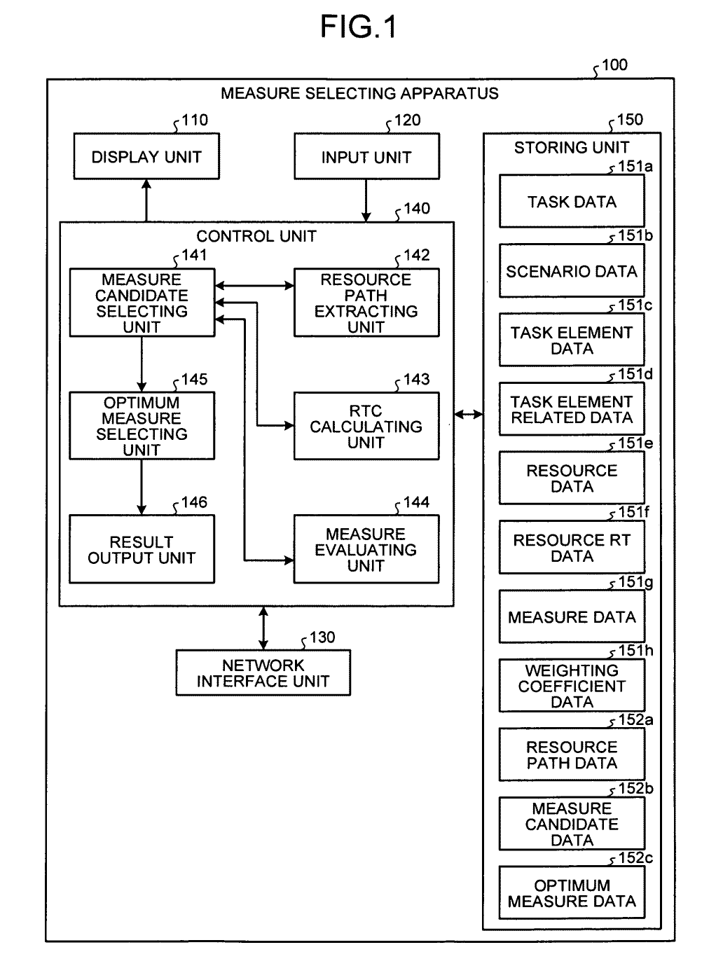

FIG. 1 is a functional block diagram illustrating the configuration of the measure selecting apparatus 100 according to the embodiment. As illustrated in FIG. 1, the measure selecting apparatus 100 includes a display unit 110, an input unit 120, a network interface unit 130, a control unit 140, and a storing unit 150.

The display unit 110 displays various kinds of information and is, for example, a liquid crystal display. The input unit 120 is a unit to which a user inputs various kinds of instruction and includes a keyboard, a mouse, and the like. The network interface unit 130 is an interface for exchanging information or the like with another device via a network.

The control unit 140 is a control unit that performs the overall control of the measure selecting apparatus 100. The control unit 140 includes a measure candidate selecting unit 141, a resource path extracting unit 142, an RTC calculating unit 143, a measure evaluating unit 144, an optimum measure selecting unit 145, and a result output unit 146.

The storing unit 150 is a storing unit that stores various kinds of information. The storing unit 150 stores therein task data 151a, scenario data 151b, task element data 151c, task element related data 151d, resource data 151e, resource RT data 151f, measure data 151g, weighting coefficient data 151h, resource path data 152a, measure candidate data 152b, and optimum measure data 152c.

In the following, each unit in the control unit 140 will be described in detail. The measure candidate selecting unit 141 controls the resource path extracting unit 142, the RTC calculating unit 143, and the measure evaluating unit 144 to select, for each task and scenario, a measure as a candidate for a measure. Multiple tasks to be developed for a BCP are defined in the task data 151a. Scenarios that are used in these tasks are defined in the scenario data 151b. By referring to the information contained in the task data 151a and the scenario data 151b, the measure candidate selecting unit 141 selects a candidate for a measure.

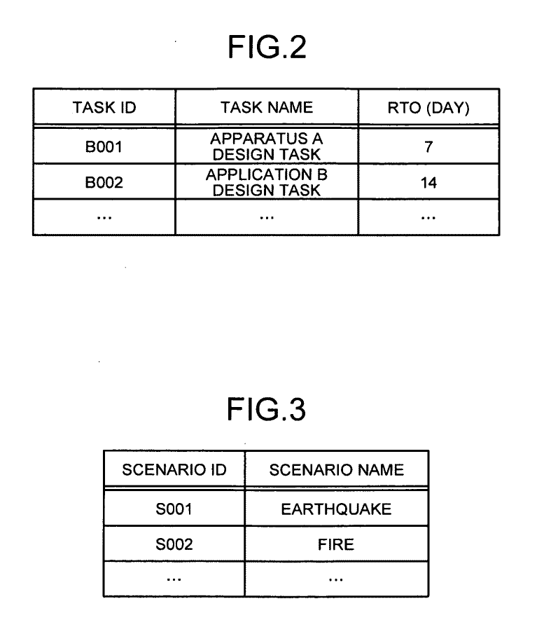

FIG. 2 is a schematic diagram illustrating an example of the task data 151a. As illustrated in FIG. 2, the task data 151a includes items such as a task ID, a task name, and an RTO. In the task data 151a, a row is registered for each task that is included in target to be developed for the BCP. The task ID is an identification number to identify a task. The task name is the name of a task. The RTO is a target value of the recovery time of the task.

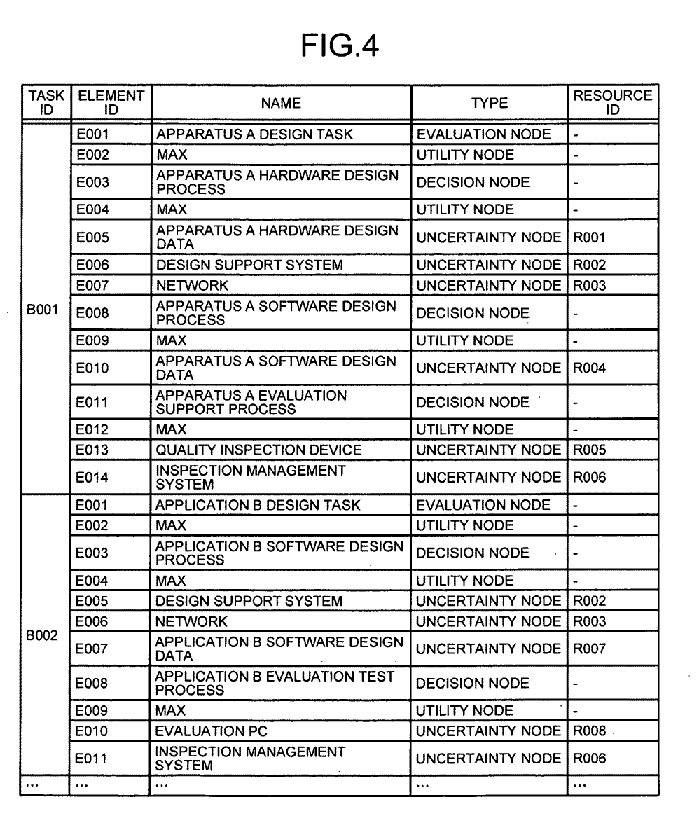

FIG. 3 is a schematic diagram illustrating an example of the scenario data 151b. As illustrated in FIG. 3, The scenario data 151b includes items such as a scenario ID and a scenario name. In the scenario data 151b, a row is registered for each scenario to be set. The scenario ID is an identification number to identify a scenario. The scenario name is the name of a scenario.

The resource path extracting unit 142 extracts, from data constituting the influence diagram, all of the resource paths included in a task that is instructed by the measure candidate selecting unit 141. The term “resource path” mentioned here means that a path joining, in accordance with the dependency relation, resources from the highest level to the end level included in the influence diagram.

In the embodiment, the influence diagram includes the task element data 151c that represents nodes and the task element related data 151d that represents the connection relation (dependency relation) between nodes. Specifically, the resource path extracting unit 142 extracts, from the data described above, a resource path; adds information stored in the resource RT data 151f or the like; and stores the information in the resource path data 152a. The extraction of the resource path is performed by referring to the task element related data 151d; searching all of the paths from the evaluation node toward a lower level; and extracting, from among nodes included on these paths, a node representing a resource, i.e., a type of “uncertainty node”, in accordance with the dependency relation.

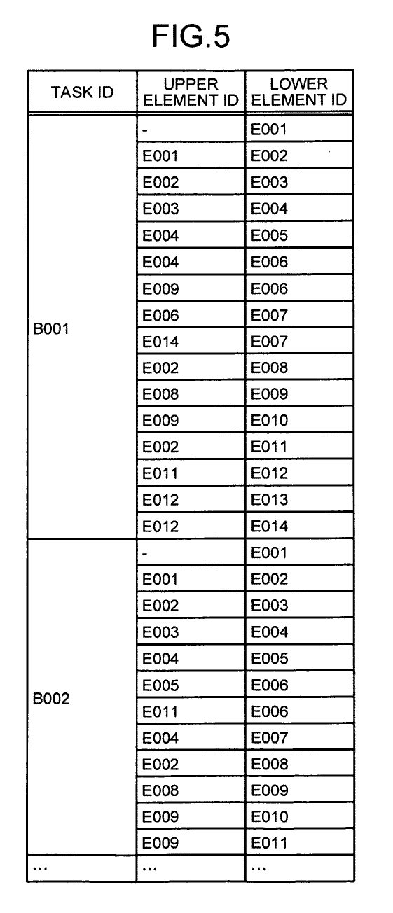

FIG. 4 is a schematic diagram illustrating an example of the task element data 151c. As illustrated in FIG. 4, the task element data 151c includes items such as a task ID, an element ID, a name, a type, and a resource ID. In the task element data 151c, a row is registered for each task ID and for each node used in the influence diagram. The task ID is an identification number to identify a task, which corresponds to the task ID stored in the task data 151a. The element ID is an identification number to identify a node. The name is the name of a node, which corresponds to a character string illustrated by a symbol of the node in the influence diagram.

The type is a node type and at least one of an “evaluation node”, “decision node”, “uncertainty node”, and “utility node” is selected as the node type. The resource ID is set when the value of the type is an “uncertainty node”, i.e., when a node is a resource, which corresponds to a resource ID stored in the resource data 151e described later.

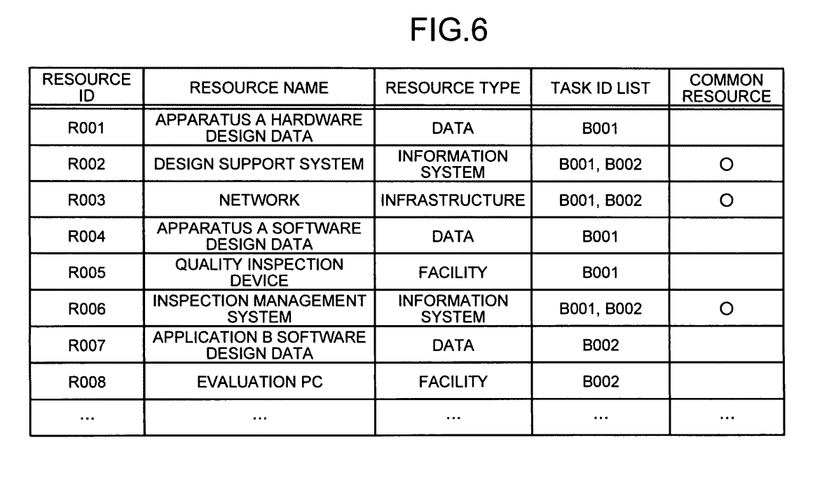

FIG. 5 is a schematic diagram illustrating an example of the task element related data 151d. As illustrated in FIG. 5, the task element related data 151d includes items such as a task ID, an upper element ID, and a lower element ID. In the task element related data 151d, each row represents the connection relation (dependency relation) between two neighboring nodes in the influence diagram. The task ID is an identification number to identify a task, which corresponds to the task ID stored in the task data 151a. The upper element ID is an identification number of a higher node in the influence diagram and the lower element ID is an identification number of a lower node in the influence diagram. The upper element ID and the lower element ID correspond to the element ID stored in the task element data 151c.

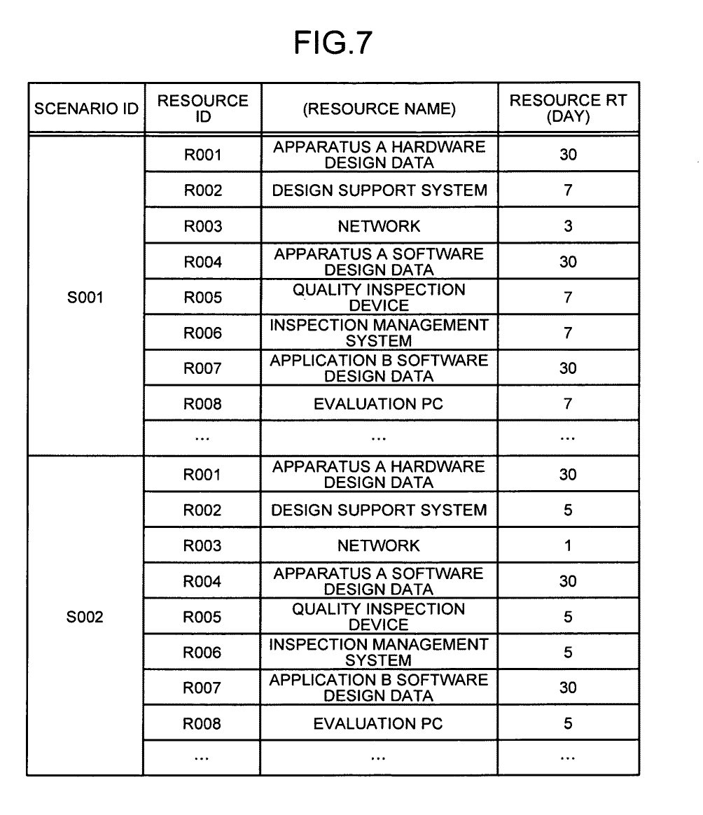

FIG. 6 is a schematic diagram illustrating an example of the resource data 151e. As illustrated in FIG. 6, the resource data 151e includes items such as a resource ID, a resource name, a resource type, a task ID list, and a common resource. In the resource data 151e, a row is registered for each resource that is used in the influence diagram. The resource ID is an identification number to identify a resource. The resource name is the name of a resource. The resource type is the type of the resource. The task ID list is an ID list of a task that corresponds to the influence diagram in which a resource is used. In a common resource, a flag is used for indicating whether a resource is a common resource, i.e., a resource that is used in multiple tasks.

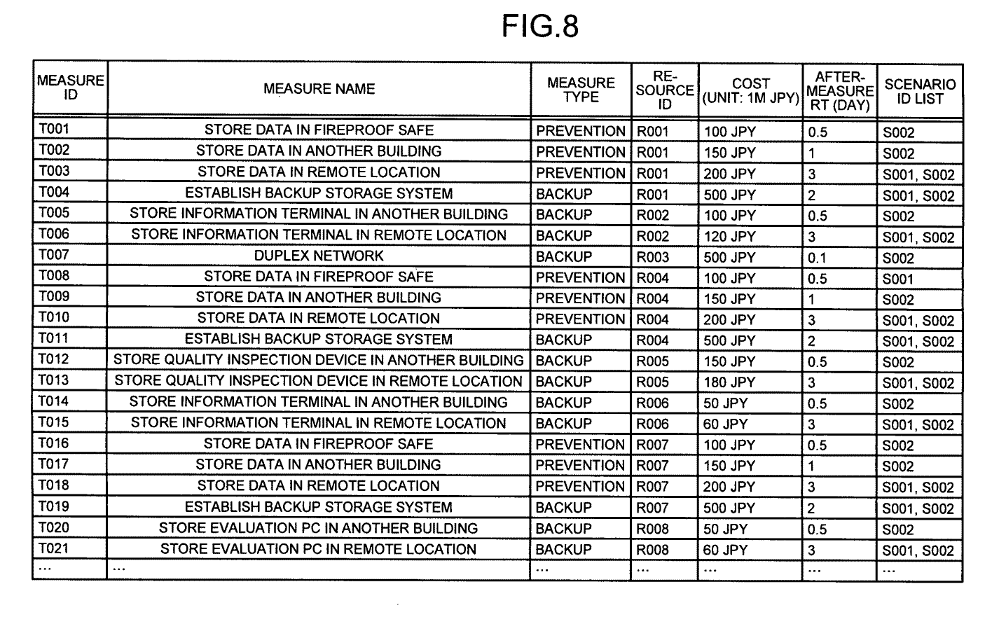

FIG. 7 is a schematic diagram illustrating an example of the resource RT data 151f. As illustrated in FIG. 7, the resource RT data 151f includes items such as a scenario ID, a resource ID, a resource name, and a resource RT. In the resource RT data 151f, the current recovery time of each resource is registered for each scenario ID. The scenario ID is an identification number to identify a scenario, which corresponds to the scenario ID stored in the scenario data 151b. The resource ID is an identification number to identify a resource, which corresponds to the resource ID stored in the resource data 151e. The resource name is the name of a resource. The resource RT is the current recovery time of a resource.

As is clear from the example illustrated in FIG. 7, even though resources are the same, if scenarios, i.e., assumed adverse events, differ, the recovery time is not always the same. This is because if adverse events differ, the type of adverse event that the resource experiences is not always the same.

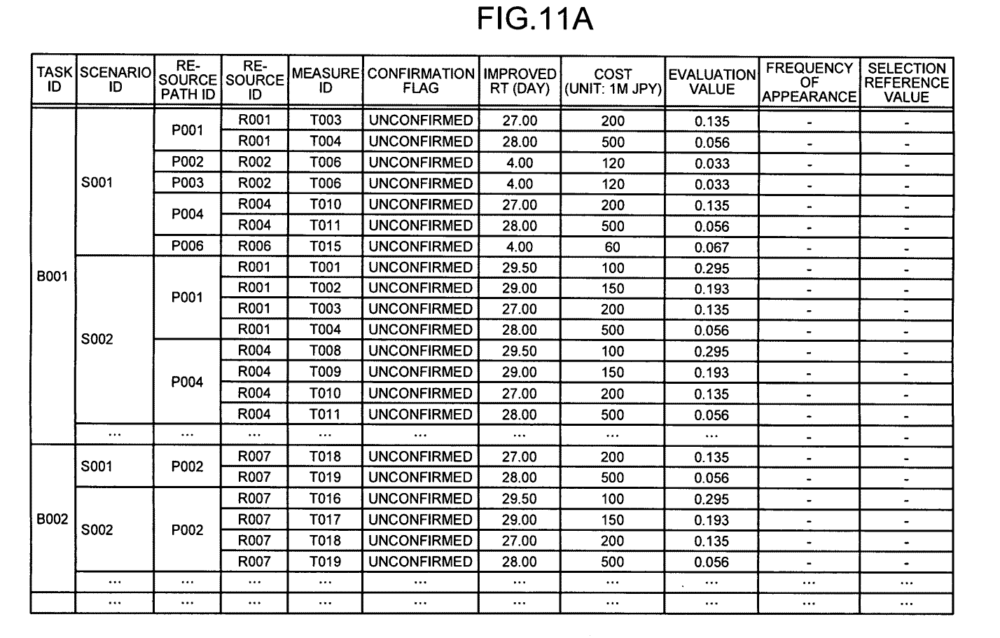

FIG. 10 is a schematic diagram illustrating an example of the resource path data 152a. As illustrated in FIG. 10, the resource path data 152a includes items such as a task ID, an RTO, a scenario ID, a resource path ID, an RTC, a resource ID, and a resource RT. The resource path data 152a is configured such that multiple combinations of a resource ID and a resource RT can be registered for each task ID, scenario ID and resource path ID.

The task ID is an identification number to identify a task, which corresponds to the task ID stored in the task data 151a. The RTO is the RTO of a task that corresponds to the task ID. In the resource path data 152a, the RTO is set by obtaining, from the task data 151a, a value of an RTO in a row of the same task ID as that in the task data 151a. The scenario ID is an identification number to identify a scenario, which corresponds to the scenario ID stored in the scenario data 151b. The resource path ID is an identification number to identify a resource path. The RTC is the RTC of a resource path, which is set by the RTC calculating unit 143.

The resource ID is an identification number that indicates a resource included on a resource path, which corresponds to the resource ID stored in the resource data 151e. The resource RT is the time needed to recover the resource if an adverse event occurs that is assumed to be part of a scenario corresponding to the scenario ID. In the resource path data 152a, the resource RT is set by obtaining, from the resource RT data 151f, a value of a resource RT in a row of the same scenario ID and the same resource ID as those in the resource path data 152a.

In first to ninth rows in the resource path data 152a illustrated in FIG. 10, six resource paths “P001” to “P006” are present as the resource paths for the scenario of the scenario ID “S001” in the task with the task ID “B001”. The resource path “P001” includes the resource “R001”. The resource paths “P002” and “P003” include the resources “R002” and “R003”. The resource path “P004” includes the resource “R004”. The resource path “P005” includes the resource “R005”. The resource path “P006” includes the resources “R006” and “R003”.

In the examples of the task element data 151c illustrated in FIG. 4 and the task element related data 151d illustrated in FIG. 5, the data in the “B001” row of the task ID is the data included in the influence diagram illustrated in FIG. 18. In the examples of the task element data 151c illustrated in FIG. 4 and the task element related data 151d illustrated in FIG. 5, the data in the “B002” row of the task ID is data included in the influence diagram illustrated in FIG. 19. The resource path data 152a illustrated in FIG. 10 includes resource paths extracted from that data illustrated in FIGS. 18 and 19.

The RTC calculating unit 143 calculates RTCs of resource paths that are included in the resource path data 152a. Specifically, the RTC calculating unit 143 obtains, from the resource path data 152a, resource RTs of all of the resources included on a specified resource path and sets, as an RTC of the resource path in the resource path data 152a, the total resource RT of the resources.

The measure evaluating unit 144 extracts candidates for a measure to be performed to reduce the RTC of a resource path so that it is equal to or less than the RTO. Specifically, the measure evaluating unit 144 selects, from measures included in the measure data 151g, a measure applicable to a resource included on the resource path until the RTC of the resource path becomes equal to or less than the RTO. This process is sequentially performed starting from the resource path having the maximum RTC and is performed until no resource path in which an RTC is greater than the RTO is present. Candidates selected for the measure in this process are registered in the measure candidate data 152b.

In this process, the measure evaluating unit 144 calculates, in accordance with a predetermined evaluation equation, evaluation values of a measure and selects the evaluation values as candidates in order of highest evaluation value first. The evaluation value E1 can be calculated using, for example, Equation (1) below:

E1=Σ(T)/C (1)

where T represents the length of recovery time of the resource that is reduced by the measure, and C represents the cost required for performing the measure. If a measure is performed on a resource belonging to multiple resource paths, the recovery time that can be reduced by the measure increases in proportion to the number of resource paths, which is taken into consideration in Equation (1). By using Equation (1), measures can be evaluated from the viewpoint of cost-effectiveness. Equation (1) described above is only for an example; therefore, it can be arbitrarily changed in accordance with the purpose. For example, when a measure is selected, if cost reduction is extremely important, it is also possible to use, instead of C, a value of the cost squared.

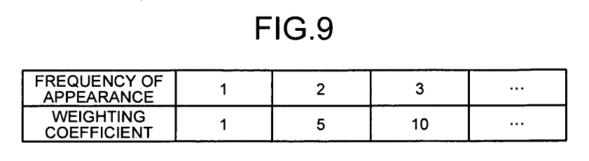

FIG. 8 is a schematic diagram illustrating an example of the measure data 151g. As illustrated in FIG. 8, the measure data 151g includes items such as a measure ID, a measure name, a measure type, a resource ID, a cost, an after-measure RT, and a scenario ID list. In the measure data 151g, a row is registered for each measure. The measure ID is an identification number to identify a measure. The measure name is the name of a measure. The measure type is the type of a measure. The resource ID is an identification number indicating a resource to be performed on the measure, which corresponds to the resource ID stored in the resource data 151e. The cost is the cost of implementing the measure. The after-measure RT is the recovery time of a resource obtained after the measure is implemented. The scenario ID list is an ID list of scenarios for which the measure can be selected.

In the example illustrated in FIG. 8, in order to represent how much the recovery time of a resource is reduced for a given measure, the recovery time obtained after a measure has been performed is set as an item in the after-measure RT column. However, instead of this item, it is also possible to create an item for the length of recovery time that is reduced by a measure or a reduction rate.

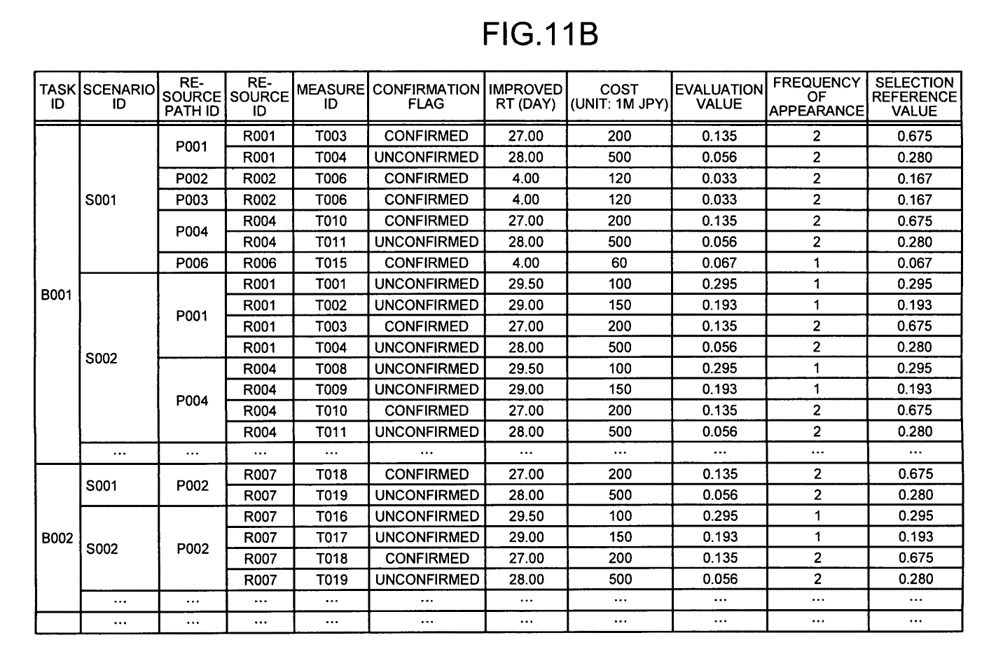

FIG. 11A is a schematic diagram illustrating an example of the measure candidate data 152b. As illustrated in FIG. 11A, the measure candidate data 152b includes items such as a task ID, a scenario ID, a resource path ID, a resource ID, a measure ID, a confirmation flag, an improved RT, a cost, an evaluation value, a frequency of appearance, and a selection reference value. In the measure candidate data 152b, for each task ID, scenario ID, and resource path ID, multiple candidates for a measure can be registered so that an RTC of a resource path corresponding to the resource path ID is made to be equal to or less than the RTO.

The task ID is an identification number to identify a task, which corresponds to the task ID stored in the task data 151a. The scenario ID is an identification number to identify a scenario, which corresponds to the scenario ID stored in the scenario data 151b. The resource path ID is an identification number to identify a resource path, which corresponds to the resource path ID stored in the resource path data 152a. The resource ID is an identification number indicating a resource included on a resource path, which corresponds to the resource ID stored in the resource data 151e.

The measure ID is an identification number to identify a candidate for a measure that is performed on a resource. The measure ID corresponds to the measure ID stored in the measure data 151g. The confirmation flag is a flag indicating whether a measure is determined to be selected as the measure; either one of “confirmed” and “unconfirmed” is selected. As in the example illustrated in FIG. 11A, the measure evaluating unit 144 can register, with respect to a single resource path, multiple measures having a value indicating an “unconfirmed” in the confirmation flag column. For a value indicating an “unconfirmed” candidate in the confirmation flag column, the optimum measure selecting unit 145 determines whether it is to be selected as a measure.

In the example illustrated in FIG. 11A, values of the confirmation flag are all “unconfirmed”. However, the measure evaluating unit 144 may possibly register, in the measure candidate data 152b, a candidate for a measure indicating a value of “confirmed” in the confirmation flag column. A process in which the measure evaluating unit 144 selects a candidate for a measure and registers it in the measure candidate data 152b will be described in detail later.

The improved RT is the length of recovery time of a resource reduced by a measure. The cost is a cost required for implementing the measure. A value that is set in the improved RT column is obtained by subtracting an after-measure RT, which is obtained from a row in the measure data 151g having the same measure ID as that in the measure candidate data 152b, from a resource RT, which is obtained from a row in the resource path data 152a having the same task ID, scenario ID, and resource ID as those in the measure candidate data 152b. The cost is set by obtaining it from a row in the measure data 151g having the same measure ID. The evaluation value is the evaluation result of the measure that is calculated using Equation (1) described above. The frequency of appearance and the selection reference value are used by the optimum measure selecting unit 145.

The optimum measure selecting unit 145 selects an optimum measure from among candidates registered in the measure candidate data 152b; associates them with a task and a resource; and registers them in the optimum measure data 152c. Specifically, the optimum measure selecting unit 145 selects, as optimum measures, candidates whose value in the confirmation flag is “confirmed”. In addition, from among candidates that have the same task ID, scenario ID, and resource path ID, and whose value in the confirmation flag is “unconfirmed”, the optimum measure selecting unit 145 also selects the highest selection reference value as an optimum measure. The selection reference value E2 is calculated, for example, using Equation (2) below:

E2=α×evaluation value (2)

where α is a weighting coefficient defined, in the weighting coefficient data 151h, in accordance with the frequency of appearance in which the same combination of a resource ID and a measure ID appears in the measure candidate data 152b. The evaluation value is a value calculated using Equation (1).

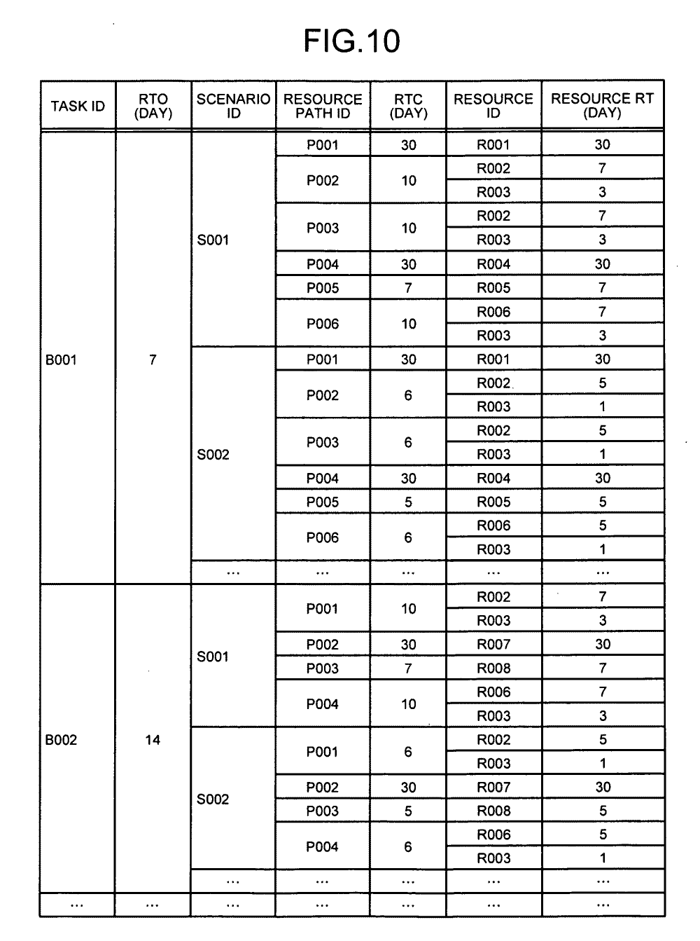

FIG. 9 is a schematic diagram illustrating an example of the weighting coefficient data 151h. In the example illustrated in FIG. 9, if the frequency of appearance is once, the weighting coefficient is “1”; if the frequency of appearance is twice, the weighting coefficient is “5”; and if the frequency of appearance is three times, the weighting coefficient is “10”. In this way, the weighting coefficient is set to be increased as the frequency of appearance becomes greater. In the calculation result of Equation (2), the weighting coefficient also increases as the frequency of appearance becomes greater.

In this way, by valuing more highly candidates that frequently appear, the candidates that frequently appear are given priority selection. The candidates that frequently appear correspond to effective measures in the multiple scenarios described above or measures that use common resources. By selecting these candidates as a priority, it is possible to efficiently reduce the recovery time of business activity with fewer measures.

FIG. 11B is a schematic diagram illustrating an example of the measure candidate data 152b in which optimum measures have been selected by the optimum measure selecting unit 145. As illustrated in FIG. 11B, the optimum measure selecting unit 145 counts the frequency of appearance of a combination of a resource ID and a measure ID; obtains, from the weighting coefficient data 151h, a weighting coefficient that corresponds to the result of the weighting coefficient; and calculates a selection reference value. After calculating selection reference values for all the candidates, the optimum measure selecting unit 145 compares the selection reference values of the candidates that have the same task ID, the same scenario ID, and the same resource path ID and whose value of their confirmation flag is “unconfirmed”. Then, the optimum measure selecting unit 145 updates the confirmation flag of the candidate having the greatest selection reference value to “confirmed”.

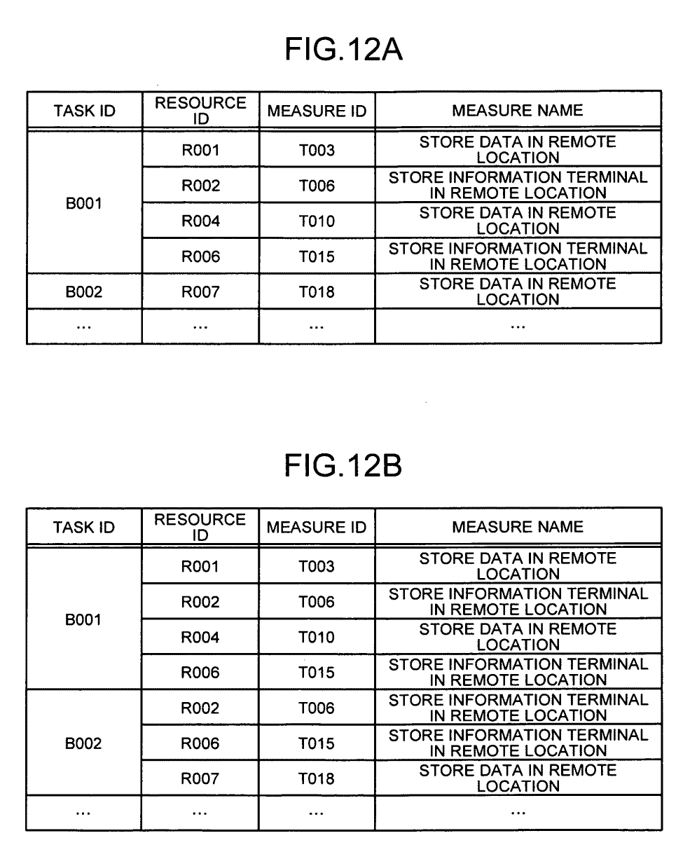

By doing so, optimum measures for resource paths are selected for each task ID and scenario ID. The optimum measure selecting unit 145 extracts, from the measure candidate data 152b, information in a row in which the confirmation flag is set to “confirmed” and registers it in the optimum measure data 152c. An example of the optimum measure data 152c at this stage is illustrated in FIG. 12A. As illustrated in FIG. 12A, the optimum measure data 152c includes items such as a task ID, a resource ID, a measure ID, and a measure name. In the optimum measure data 152c, a row is registered for each measure selected. The optimum measure selecting unit 145 is controlled to avoid registering, in the optimum measure data 152c, rows having the same content in a duplicate manner.

After the optimum measure selecting unit 145 registers, in the optimum measure data 152c, information extracted from the measure candidate data 152b, if a measure that uses a common resource is in the optimum measure data 152c, the optimum measure selecting unit 145 performs a process for making the optimum measure data 152c consistent. For example, in the example of the optimum measure data 152c illustrated in FIG. 12A, in the task “B001”, measures are performed on the resource “R002” and the resource “R006”. As illustrated in FIG. 6, these resources are common resources with the task “B002”. Accordingly, if measures are performed on these resources in the task “B001”, the measures are inevitably performed in the task “B002”. Therefore, as illustrated in FIG. 12B, the optimum measure selecting unit 145 additionally registers, in the task “B002”, measures that are performed on the resource “R002” and the resource “R006” in the task “B001”.

The result output unit 146 outputs, as a result of selecting a measure, the content of the optimum measure data 152c or the like. The type of format that is used when the result output unit 146 outputs information stored in the storing unit 150 can be arbitrarily changed in accordance with an object.

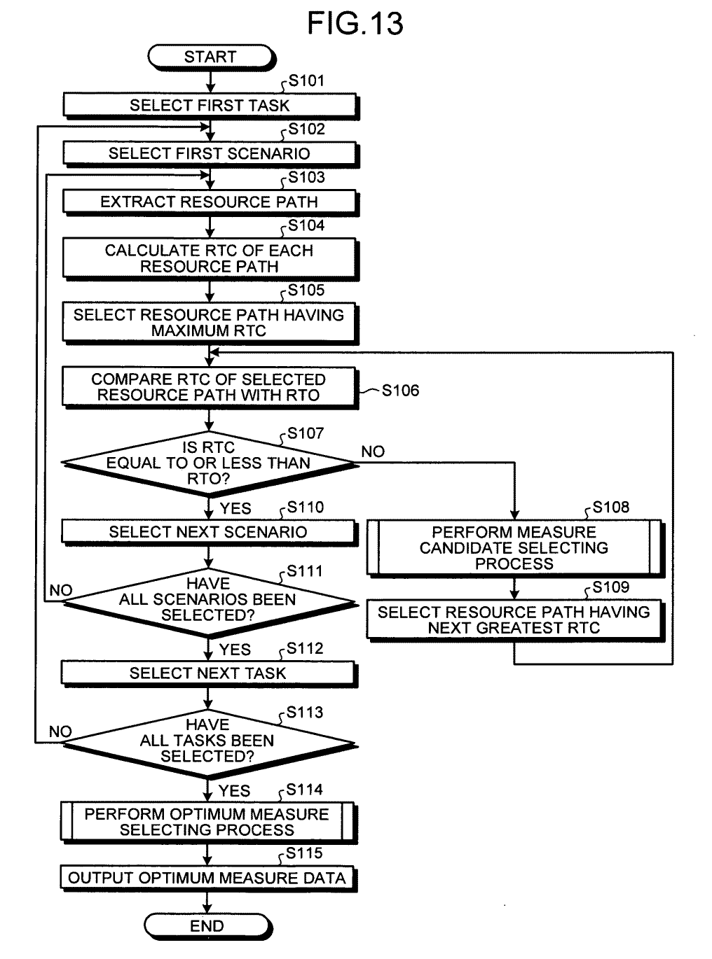

In the following, the flow of a process performed by the measure selecting apparatus 100 will be described. FIG. 13 is a flowchart illustrating the flow of a process performed by the measure selecting apparatus 100. As illustrated in FIG. 13, in the measure selecting apparatus 100, first, the measure candidate selecting unit 141 selects a first task that is registered in the task data 151a (Step S101). Then, the measure candidate selecting unit 141 selects a first scenario that is registered in the scenario data 151b (Step S102).

The measure candidate selecting unit 141 specifies the task ID of the obtained task and the scenario ID of the obtained scenario and allows the resource path extracting unit 142 to extract a resource path. By referring to the task element data 151c and the task element related data 151d, the resource path extracting unit 142 extracts a resource path included in the task corresponding to the specified task ID; adds a resource RT or the like that is registered in the resource RT data; and registers, in the resource path data 152a, information about the extracted resource path (Step S103).

Subsequently, the measure candidate selecting unit 141 allows the RTC calculating unit 143 to calculate the RTC of each resource path that is newly extracted by the resource path extracting unit 142 (Step S104). Then, from among the resource paths that are newly extracted by the resource path extracting unit 142, the measure candidate selecting unit 141 selects the maximum RTC (Step S105) and compares the RTC of the selected resource path with an RTO that is obtained from the task data 151a (Step S106).

If the RTC is greater than the RTO (No at Step S107), the measure candidate selecting unit 141 specifies the task ID of the obtained task, the scenario ID of the obtained scenario, the resource path ID of the selected resource path, and the RTO obtained from the task data 151a and then allows the measure evaluating unit 144 to perform a measure candidate selecting process. In this way, a candidate for a measure, which is used to reduce the RTC of the resource path corresponding to that resource path ID so that it is equal to or less than the RTO, is registered in the measure candidate data 152b (Step S108). After the measure evaluating unit 144 completes the measure candidate selecting process, the measure candidate selecting unit 141 selects a resource path that has the next greatest RTC (Step S109) and resumes the process from Step S106.

In contrast, if the RTC is equal to or less than the RTO at Step S106 (Yes at Step S107), the measure candidate selecting unit 141 selects the next scenario that is registered in the scenario data 151b (Step S110). At this stage, if the next scenario can be obtained (No at Step S111), the measure candidate selecting unit 141 resumes the process from Step S103. If all of the scenarios have been selected and the next scenario cannot be obtained (Yes at Step S111), the measure candidate selecting unit 141 selects the next task that is registered in the task data 151a (Step S112).

If the next task can be obtained (No at Step S113), the measure candidate selecting unit 141 resumes the process from Step S102. If all of the tasks have been selected and the next task cannot be obtained (Yes at Step S113), the optimum measure selecting unit 145 performs an optimum measure selecting process, which will be described later (Step S114). Then, the result output unit 146, for example, outputs the content of the optimum measure data 152c in which information about the selected measure is registered (Step S115).

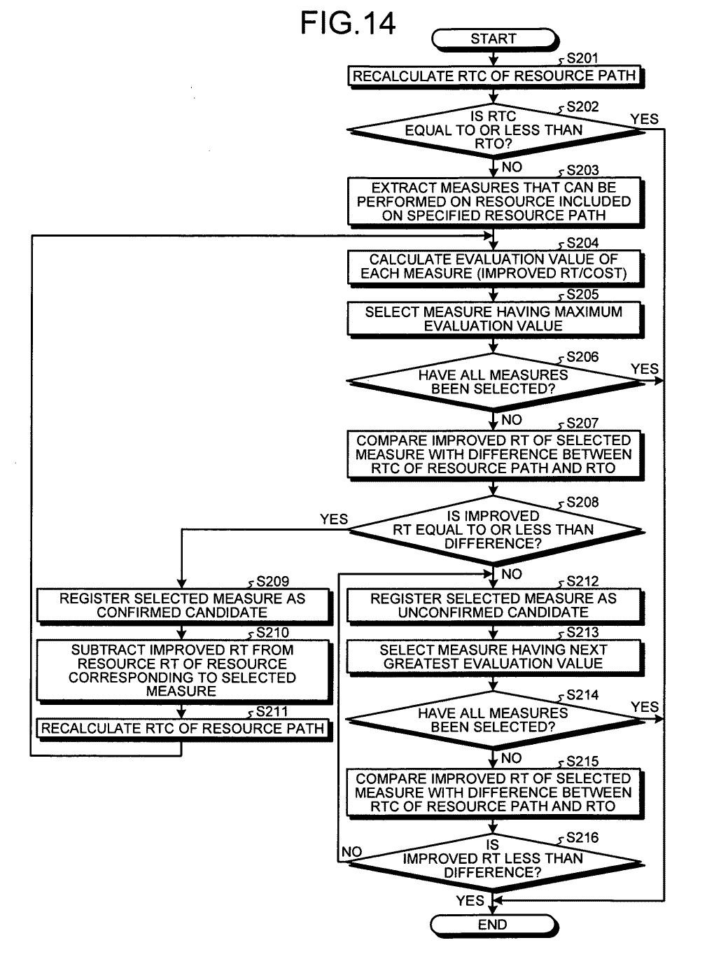

FIG. 14 is a flowchart illustrating the flow of the measure candidate selecting process illustrated in FIG. 13. As illustrated in FIG. 14, first, the measure evaluating unit 144 allows the RTC calculating unit 143 to recalculate the RTC of the resource path that corresponds to the specified resource path ID (Step S201). Then, the measure evaluating unit 144 checks whether the calculated RTC is equal to or less than the RTO. If the RTC is equal to or less than the RTO (Yes at Step S202), the measure evaluating unit 144 completes the measure candidate selecting process. If a resource that is included on that resource path is also included another resource path, there may be a case in which, due to a measure that has been selected by the other resource path, the RTC of that resource path may become equal to or less than the RTO, and thus the need for measures other than that measure is eliminated. The above process is performed to avoid selecting an extra measure in such a case.

If the RTC calculated at Step S201 is greater than the RTO (No at Step S202), the measure evaluating unit 144 can perform a process on a scenario that corresponds to the specified scenario ID. The measure evaluating unit 144 extracts, from the measure data 151g, all of the measures that can be performed in a scenario corresponding to the specified scenario ID and that can be performed on a resource included on a resource path corresponding to the specified resource path ID. Specifically, the measure evaluating unit 144 obtains, from the measure data 151g, all of the rows of the same resource ID of a resource, included on a resource path that corresponds to the resource path ID to which the resource ID is specified and also obtains the rows having the same scenario ID included in the scenario ID list column to which one of the scenario IDs is specified (Step S203).

Subsequently, using Equation (1) described above, the measure evaluating unit 144 calculates an evaluation value of each of the extracted measures (Step S204) and selects a measure having the maximum evaluation value (Step S205). Then, if a measure can be selected (No at Step S206), the measure evaluating unit 144 compares an improved RT of that measure with the difference between the RTC of the resource path and the RTO (Step S207). At this stage, if the improved RT is equal to or less than the difference, i.e., if it is a case in which the RTC cannot be made equal to or less than the RTO without performing at least that measure (Yes at Step S208), the measure evaluating unit 144 register, in the measure candidate data 152b, the selected candidate as a confirmed candidate whose value of the confirmation flag is “confirmed” (Step S209).

Furthermore, the measure evaluating unit 144 performs, on the resource path data 152a, a process for subtracting the improved RT from the resource RT of the resource corresponding to that measure and reflects the improvement obtained by the selected measure in the resource path data 152a (Step S210). This reflecting process is performed on all of the rows in which a task ID is equal to the specified task ID, a scenario ID is equal to the specified scenario ID, a resource path ID is equal to the specified resource path ID, and a resource ID is equal to the resource ID of the resource that corresponds to the specified measure. Then, the measure evaluating unit 144 allows the RTC calculating unit 143 to recalculate the RTC of the resource path that corresponds to the specified resource path ID (Step S211), and resumes the process from Step S204.

In contrast, if the measure evaluating unit 144 cannot select a measure because all of the measures have been selected at Step S205, i.e., there is no measure that can make the RTC equal to or less than the RTO (Yes at Step S206), the measure evaluating unit 144 completes the measure candidate selecting process.

Furthermore, if the improved RT exceeds the difference at Step S207, i.e., if the measure evaluating unit 144 can selects a measure that can make the RTC equal to or less than the RTO (No at Step S208), the measure evaluating unit 144 registers, in the measure candidate data 152b, the selected candidate as an unconfirmed candidate whose value of the confirmation flag is “unconfirmed” (Step S212) and then searches for other measures that can make the RTC equal to or less than the RTO.

Specifically, the measure evaluating unit 144 selects a measure having the next greater evaluation value (Step S213). If the measure evaluating unit 144 can select a measure (No at Step S214), the measure evaluating unit 144 compares the improved RT of the measure with the difference between the RTC of the resource path and the RTO (Step S215). If the improved RT is equal to or greater than the difference (No at Step S216), the measure evaluating unit 144 registers the measure as an unconfirmed candidate in the measure candidate data 152b (Step S212). This process is repeatedly performed until all of the measures have been selected (Yes at Step S214), or until the improved RT becomes smaller than the difference (Yes at Step S216).

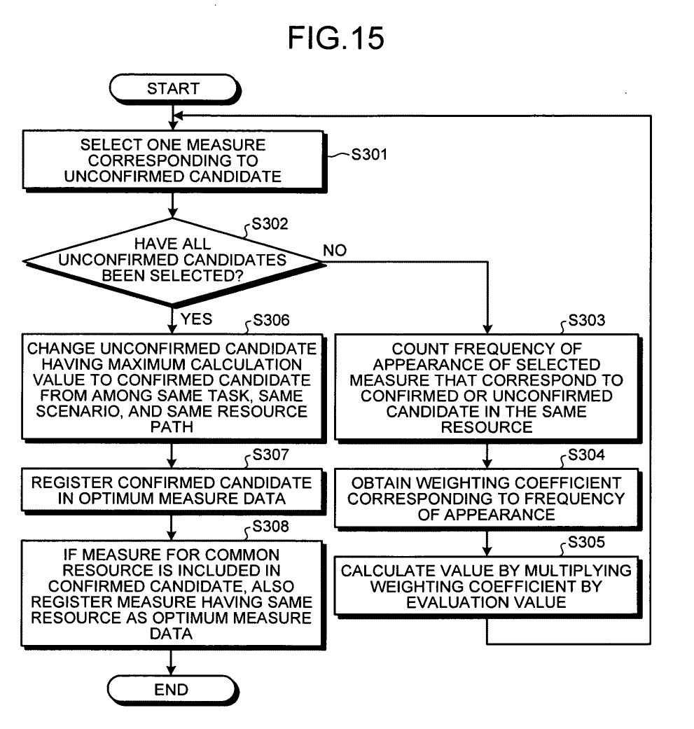

FIG. 15 is a flowchart illustrating the flow of the optimum measure selecting process illustrated in FIG. 13. As illustrated in FIG. 15, first, the optimum measure selecting unit 145 selects one unconfirmed candidate from among the candidates whose confirmation flags are set to “unconfirmed” in the in the measure candidate data 152b (Step S301).

If the optimum measure selecting unit 145 can select an unconfirmed candidate at this stage (No at Step S302), the optimum measure selecting unit 145 counts, as the frequency of appearance, the number of confirmed candidates or unconfirmed candidates, for the selected measures in the measure candidate data 152b, with respect to a resource corresponding to the target resource for the measure (Step S303). Then, the optimum measure selecting unit 145 obtains, from the weighting coefficient data 151h, a weighting coefficient that corresponds to the frequency of appearance (Step S304); calculates, using Equation (2) described above, a selection reference value (Step S305); and then tries to select the next unconfirmed candidate by returning to Step S301.

If all of the unconfirmed candidates have been selected (Yes at Step S302), from among the combinations of unconfirmed candidates having the same task, the same scenario, and the same resource path in the measure candidate data 152b, the optimum measure selecting unit 145 changes the candidate having the maximum selection reference value to a confirmed candidate (Step S306) and registers the confirmed candidate in the optimum measure data 152c (Step S307). Then, if a measure for a common resource is included among the confirmed candidates, the optimum measure selecting unit 145 also registers, in the optimum measure data 152c, the same measure that use the same resource that is in another task (Step S308).

The configuration of the measure selecting apparatus 100 according to the embodiment illustrated in FIG. 1 is not limited thereto. Various modifications are possible as long as they do not depart from the spirit of the present invention. For example, a function identical to that of the measure selecting apparatus 100 can be implemented by installing a function included in the control unit 140 of the measure selecting apparatus 100 as software and causing a computer to execute it. In the following, an example of a computer that executes a measure selecting program 1071 in which the function included in the control unit 140 is installed as software will be described.

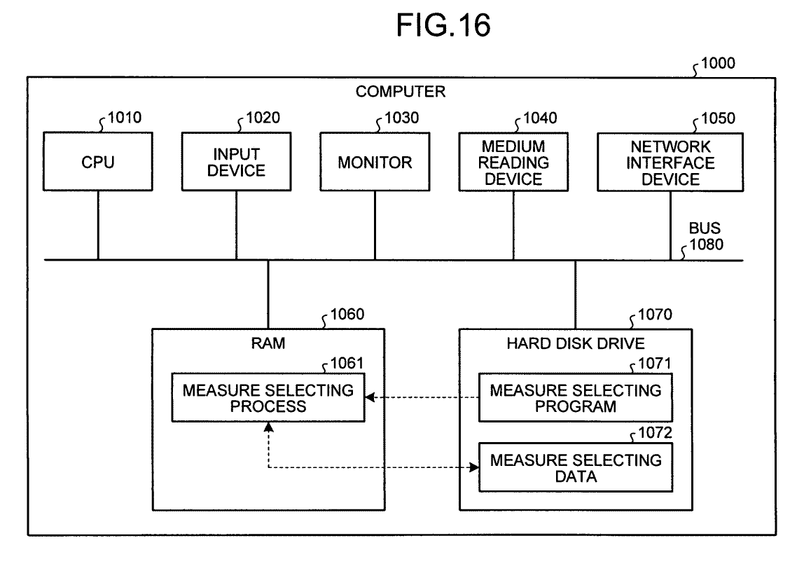

FIG. 16 is a functional block diagram illustrating a computer 1000 that executes the measure selecting program 1071. The computer 1000 includes a central processing unit (CPU) 1010 that executes various kinds of computing processing, an input device 1020 that receives data from a user, a monitor 1030 that displays various kinds of information, a medium reading device 1040 that reads programs or the like from a recording medium, a network interface device 1050 that receives/transmits data between other computers via a network, a random access memory (RAM) 1060 that temporarily stores therein various kinds of information, and a hard disk drive 1070, which are all connected via a bus 1080.

In the hard disk drive 1070, the measure selecting program 1071 that has a function identical to that included in the control unit 140 illustrated in FIG. 1 is stored and a measure selecting data 1072 corresponding to the various data stored in the storing unit 150 illustrated in FIG. 1 is stored. Furthermore, the measure selecting data 1072 can appropriately be separated and stored in another computer that is connected via a network.

The CPU 1010 reads the measure selecting program 1071 from the hard disk drive 1070 and expands it in the RAM 1060, whereby the measure selecting program 1071 functions as the measure selecting process 1061. Then, the measure selecting process 1061 expands, in an area allocated to the measure selecting process 1061 in the RAM 1060, information or the like that is read from the measure selecting data 1072 and executes various data processing on the basis of the expanded data or the like.

The measure selecting program 1071 is not necessarily stored in the hard disk drive 1070. For example, the computer 1000 can read the program stored in the storage medium such as a CD-ROM and executes it. Alternatively, the measure selecting program 1071 can be stored in another computer (or a server) that is connected to the computer 1000 via a public circuit, the Internet, a local area network (LAN), a wide area network (WAN), or the like and the computer 1000 then reads and executes the program from the above.

According to an aspect of the present invention, after measures that become candidates are selected, a measure is selected from among candidates using, as an index, the number of times the same measure is selected as a candidate. Accordingly, measures that are often selected as a candidate are given priority selection. It is highly likely that the measures that are often selected as a candidate are effective against multiple disasters or for multiple tasks. By selecting such measures as a priority, it is possible to efficiently create, with fewer measures, optimum combinations of measures that can make the recovery time of business equal to or less than a target value.

The present invention is effective when components of the measure selecting apparatus, descriptions, and any combination of components disclosed in the present invention are applied to methods, apparatuses, systems, computer programs, recording media, data structure, and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer readable storage medium having stored therein a measure selecting program for selecting a measure to be performed to make a recovery time required for recovering business equal to or less than a target value, the measure selecting program causing a computer to execute a process comprising:
calculating, based on information in which resources that are included in the business, measures that are performed on the resources, and information that indicates a length of recovery time of each resource at the time of performing a corresponding measure are defined, evaluation values indicating degrees of effectiveness of the respective measures;
selecting at least two candidates for at least one of the measures to be performed, based on the calculated evaluation values; and
selecting, in accordance with the evaluation values and the number of same measures included in the selected candidates, the at least one of the measures to be performed from among the selected candidates.

2. The computer readable storage medium according to claim 1, wherein
the selecting the at least two candidates includes selecting at least two candidates for the at least one of the measures to be performed for each business that is constituted of one or more resources included in the business, and
the selecting the at least one of the measures includes selecting, based on the evaluation values and the number of same measures included in all of the candidates selected by the measure candidate selecting unit, the at least one of the measures to be performed for each business from among the selected candidates.

3. The computer readable storage medium according to claim 1, wherein the selecting the at least one of the measures includes selecting, in accordance with a value obtained by multiplying the corresponding evaluation value by a coefficient that is defined in accordance with the number of same measures included in the selected candidates, the at least one of the measures to be performed from among the selected candidates.

4. A measure selecting apparatus for selecting a measure to be performed to make a recovery time required for recovering business equal to or less than a target value, the measure selecting apparatus comprising:
a measure candidate selecting unit that calculates, based on information in which resources that are included in the business, measures that are performed on the resources, and information that indicates a length of recovery time of each resource at the time of performing a corresponding measure are defined, evaluation values indicating degrees of effectiveness of the respective measures, the measure candidate selecting unit selecting at least two candidates for at least one of the measures to be performed, based on the calculated evaluation values; and
a measure selecting unit that selects, in accordance with the evaluation values and the number of same measures included in the selected candidates, the at least one of the measures to be performed from among the selected candidates.

5. The measure selecting apparatus according to claim 4, wherein
the measure candidate selecting unit selects at least two candidates for the at least one of the measures to be performed for each business that is constituted of one or more resources included in the business, and
the measure selecting unit selects, based on the evaluation values and the number of same measures included in all of the candidates selected by the measure candidate selecting unit, the at least one of the measures to be performed for each business from among the selected candidates.

6. The measure selecting apparatus according to claim 4, wherein the measure selecting unit selects, in accordance with a value obtained by multiplying the corresponding evaluation value by a coefficient that is defined in accordance with the number of same measures included in the selected candidates, the at least one of the measures to be performed from among the selected candidates.

7. A measure selecting method for selecting a measure to be performed to make a recovery time required for recovering business equal to or less than a target value, the measure selecting method comprising:
calculating, based on information in which resources that are included in the business, measures that are performed on the resources, and information that indicates a length of recovery time of each resource at the time of performing a corresponding measure are defined, evaluation values indicating degrees of effectiveness of the respective measures;
selecting at least two candidates for at least one of the measures to be performed, based on the calculated evaluation values; and
selecting, in accordance with the evaluation values and the number of same measures included in the selected candidates, the at least one of the measures to be performed from among the selected candidates.

8. The measure selecting method according to claim 7, wherein
the selecting the at least two candidates includes selecting at least two candidates for the at least one of the measures to be performed for each business that is constituted of one or more resources included in the business, and
the selecting the at least one of the measures includes selecting, based on the evaluation values and the number of same measures included in all of the candidates selected by the measure candidate selecting unit, the at least one of the measures to be performed for each business from among the selected candidates.

9. The measure selecting method according to claim 7, wherein the selecting the at least one of the measures includes selecting, in accordance with a value obtained by multiplying the corresponding evaluation value by a coefficient that is defined in accordance with the number of same measures included in the selected candidates, the at least one of the measures to be performed from among the selected candidates.
